(19) United States
(12) Patent Application Publication
(10) Pub. No.: US 2010/0162163 A1
(43) Pub. Date: Jun. 24, 2010

(54) Image magnification

(75) Inventors: Hao Wang, Beijing (CN); Kun Yu, Beijing (CN)

Correspondence Address: HARRINGTON & SMITH, 4 RESEARCH DRIVE, Suite 202, SHELTON, CT, 06484-6212, US

(73) Assignee: Nokia Corporation

(21) Appl. No.: 12/317,273

(22) Filed: Dec. 18, 2008

(51) Int. Cl. G06F 3/048

(52) U.S. Cl. 715/800; 345/173; 345/179

(57) ABSTRACT

Disclosed herein is an apparatus. The apparatus includes a touch screen. The apparatus is configured to display an image having a first area on the touch screen. The apparatus is configured to simultaneously display an enlarged view of the first area on the touch screen. The apparatus is configured to receive a touch at the enlarged view of the first area on the touch screen. The apparatus is configured to edit the image in response to the touch at the enlarged view.

### BACKGROUND

1. Field of the Invention

The invention relates to an electronic device and, more particularly, to image magnification for an electronic device.

2. Brief Description of Prior Developments

As electronic devices provide more and more functionality, many of these devices provide various user interface configurations. For example, some electronic devices have configurations allowing for pen (or stylus) interaction with a touch screen. However, many of these devices offer limited touch screen areas. With diverse functionalities, mobile devices may support the interaction of the users (with the pen/stylus) with multiple interfaces, which may include, for example, the manipulation of large images, and wide pages of text. Although the size of screens in electronic devices have become larger in recent years, these devices tend to result in generally inconvenient and inefficient configurations for user operation.

For example, as the users of the devices attempt to write or edit on the display screen, there is usually a substantial amount of the total image which is not displayed on the screen. The user may often take substantial efforts in manipulating scroll bars or scroll buttons in an inconvenient manner to utilize more writing space within the page. Additionally, users may adapt herself/himself to the limitations of the display or the writing area size, which may require additional time and added patience of the user.

### SUMMARY

In accordance with one aspect of the invention, an apparatus is disclosed. The apparatus includes a touch screen. The apparatus is configured to display an image having a first area on the touch screen. The apparatus is configured to simultaneously display an enlarged view of the first area on the touch screen. The apparatus is configured to receive a touch at the enlarged view of the first area on the touch screen. The apparatus is configured to edit the image in response to the touch at the enlarged view.

In accordance with another aspect of the invention, a method is disclosed. A first touch is sensed on a first area of a graphical image displayed on a screen. A window is provided over a second area of the graphical image. An enlarged view of the first area is displayed in the window. A second touch on the enlarged view of the first area is sensed in the window. A portion of the first area is modified in response to the second touch.

In accordance with another aspect of the invention, a method is disclosed. A first touch is sensed on a first area of a graphical image displayed on a screen. A window is provided over a second area of the graphical image. The second area is spaced from the first area. A view of the first area is displayed in the window. A movement of the first touch is determined. The window is moved from the second area to a third area in response to the determined movement of the first touch when the determined movement of the first touch is proximate the second area.

In accordance with another aspect of the invention, a program storage device readable by a machine, tangibly embodying a program of instructions executable by the machine for performing operations to edit an image is disclosed. A first touch is sensed on a first area of an image displayed on a screen. A window is provided over a second area of the image. An enlarged view of the first area is displayed in the window. A second touch on the enlarged view of the first area is sensed in the window. A portion of the first area is modified in response to the second touch.

### BRIEF DESCRIPTION OF THE DRAWINGS

The foregoing aspects and other features of the invention are explained in the following description, taken in connection with the accompanying drawings, wherein:

FIG. 1 is a perspective view of an electronic device incorporating features of the invention;

FIG. 2 is a view of a touch screen display of the device shown in FIG. 1;

FIG. 3 is another view of the touch screen display of the device shown in FIG. 1 before a first touch screen operation;

FIG. 4 is another view of the touch screen display of the device shown in FIG. 1 after a first touch screen operation;

FIG. 5 is another view of the touch screen display of the device shown in FIG. 1 after a first edit operation;

FIG. 6 is another view of the touch screen display of the device shown in FIG. 1 illustrating a moving touch operation;

FIG. 7 is a view of a window shown in the touch screen display shown in FIG. 6;

FIG. 8 is another view of the touch screen display of the device shown in FIG. 1 illustrating an area of a touch operation;

FIG. 9 is another view of the touch screen display of the device shown in FIG. 1 illustrating the area of a touch operation in a second location;

FIG. 10 is another view of the touch screen display of the device shown in FIG. 1 illustrating a movable floating window in a second position;

FIG. 11 is another view of the touch screen display of the device shown in FIG. 1 illustrating a touch operation at an edge of the window;

FIG. 12 is another view of the touch screen display of the device shown in FIG. 11 illustrating a touch operation changing a size of the window;

FIG. 13 is an electronic device in accordance with another embodiment of the invention;

FIG. 14 is a block diagram of an exemplary method of the device shown in FIGS. 1, 13;

FIG. 15 is a block diagram of another exemplary method of the device shown in FIGS. 1, 13; and

FIG. 16 is schematic drawing illustrating components of the device shown in FIGS. 1, 13.

### DETAILED DESCRIPTION

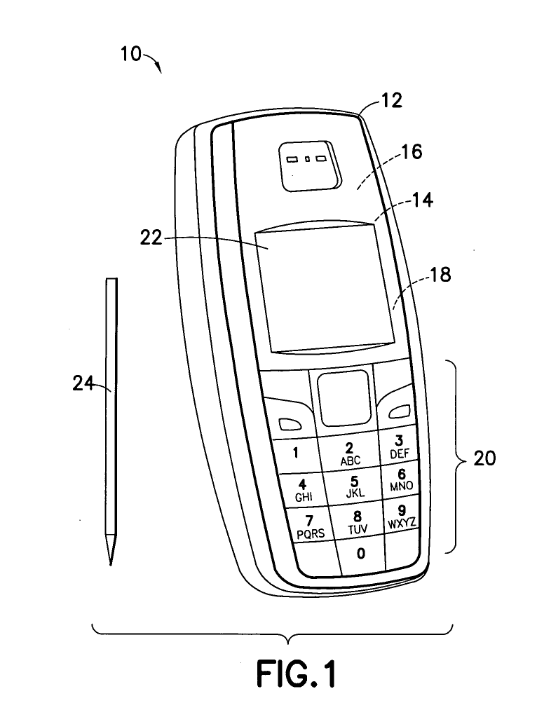

Referring to FIG. 1, there is shown a perspective view of an electronic device 10 incorporating features of the invention. Although the invention will be described with reference to the exemplary embodiments shown in the drawings, it should be understood that the invention can be embodied in many alternate forms of embodiments. In addition, any suitable size, shape or type of elements or materials could be used.

According to one example of the invention shown in FIG. 1, the device 10 is a multi-function portable electronic device. However, in alternate embodiments, features of the various embodiments of the invention could be used in any suitable type of portable electronic device such as a mobile phone, a gaming device, a music player, a notebook computer, or a PDA, for example. In addition, as is known in the art, the device 10 can include multiple features or applications such as a camera, a music player, a game player, or an Internet browser, for example. The device 10 generally comprises a housing 12, a transceiver 14 connected to an antenna 16, electronic circuitry 18, such as a controller and a memory for example, within the housing 12, a user input region 20 and a display 22. The display 22 could also form a user input section, such as a touch screen. It should be noted that in alternate embodiments, the device 10 can have any suitable type of features as known in the art.

The device 10 may also comprise a pen or stylus 24. The pen or stylus 24 is configured to allow a user of the device 10 to perform touch screen operations on the touch screen 22. The touch screen operation may be any device user operation, such as a touch on the touch screen 22 with the pen 24 to indicate file selection, or a touch on the touch screen 22 with the pen 24 to indicate an application change, for example.

The device 10 is configured to allow users of the device to view various file formats, such as image file formats, for example, on the touch screen (or touch screen display) 22. However, according to various exemplary embodiments of the invention, any suitable type of file or media may be displayed on the touch screen 22.

Embodiments of the invention provide the pen or stylus 24 as a user interface (UI) for image local magnification and editing on the display 22. According to various embodiments of the invention, a floating window may be provided over a view of an image on the display to monitor the details of a selected area, and to support the edit and modification performed by the end user.

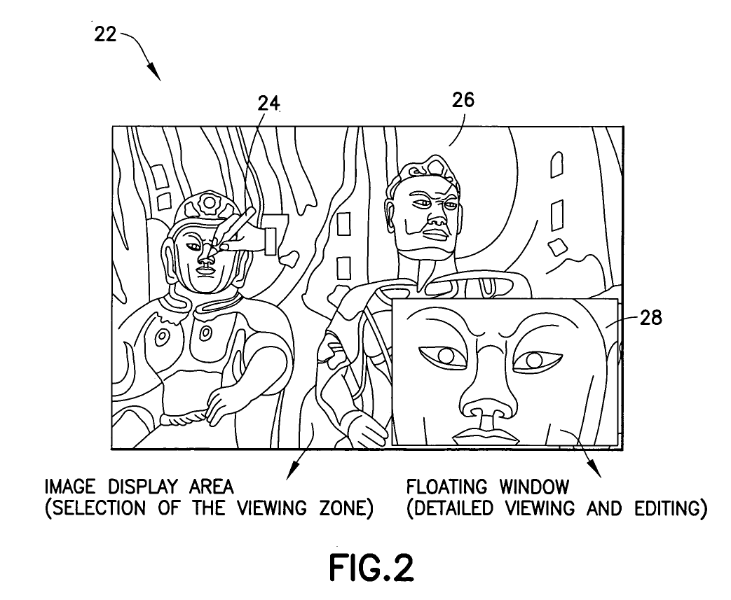

Referring now also to FIG. 2, a graphical image 26 may be displayed on the touch screen user interface 22. The graphical image 26, which may also be referred to as the panorama view, may be for example a full screen view or maximized view of the image which forms an image display area on the touch screen 22. When the image 26 is displayed, the touchscreen user interface 22 comprises two viewable parts, which may be for example, the overall full screen image 26 and a floating window 28. The image 26 may be used for navigation by ‘click’ (or touch) operations from users using the pen 24 to make contact with the display 22. The first touch operation on the display 22 may be utilized to locate a zone in the view (or selection of the viewing area) which corresponds to the view shown in the window 28. As shown if FIG. 2, a touch with the pen 24 on the image 26 provides an enlarged view of the area proximate the touch, such as an enlarged view of a face for example. Additionally, the floating window (or floating view) could be used to edit the details of the selected zone, or for detailed viewing of the selected zone, for example. It should be noted that although the figures illustrate the image as a full screen view, any suitable image size may be provided. For example in some embodiments, an image covering a portion of the display screen size may be provided.

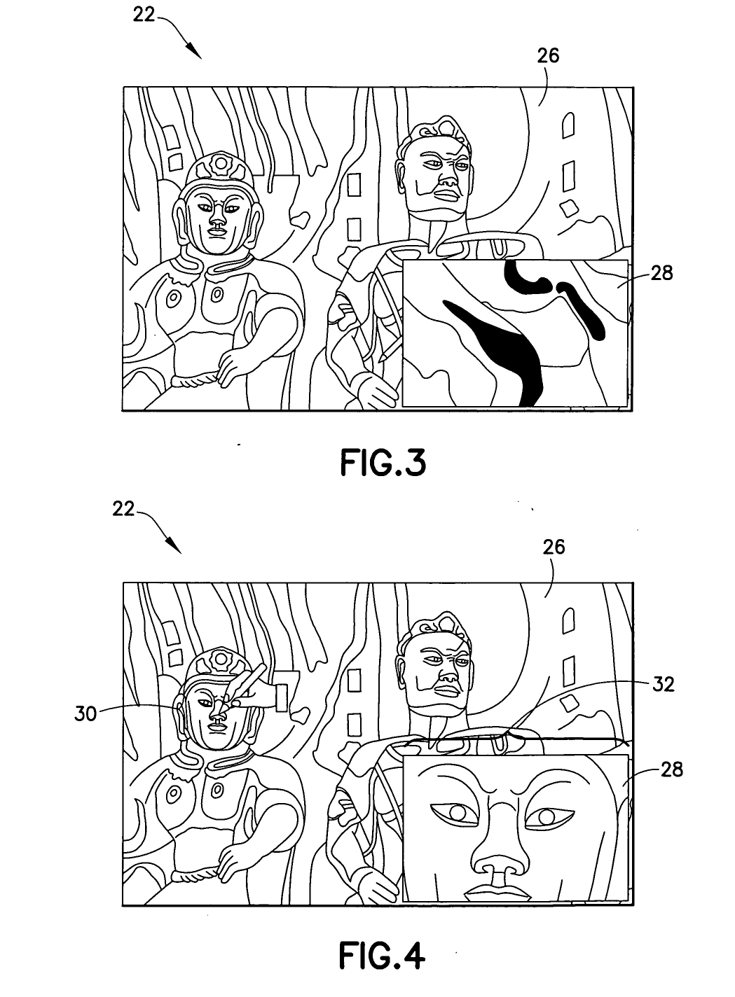

For example, referring now also to FIGS. 3-5, when the user initially views the image 26 on the touch screen display 22, and before any contact with the pen 24 is made on the screen 22, the window 28 may display a translucent view of the portion of the image 26 it is over (see FIG. 3). In some embodiments, the window 28 may instead show a solid color, such as black or white for example, prior to a touch operation on the screen 22. However, any suitable view may be provided in the window 28.

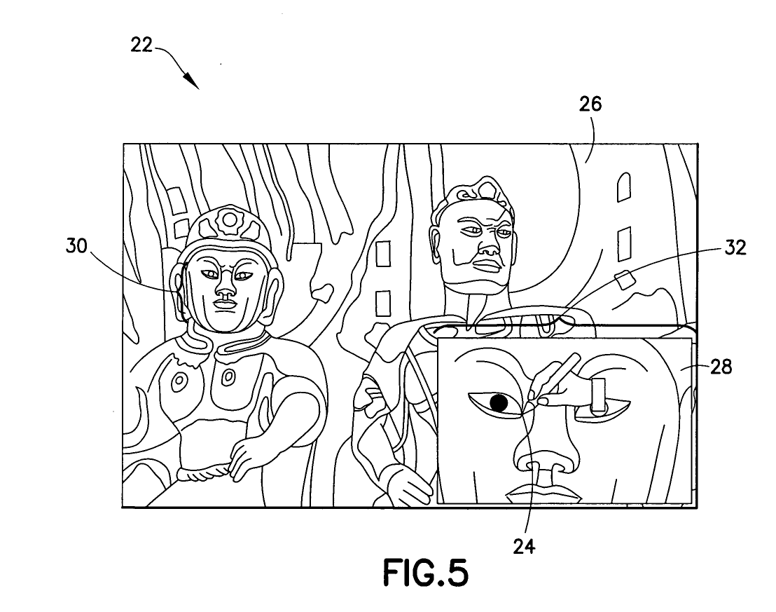

When the user performs a first touch (or click) on the image 26 with the pen 24, details of the zone (or first area) 30 around the clicking point are shown in the floating window 28 simultaneously. The floating window 28 may be provided at a second area 32 of the image 26. The second area 32 may be, for example, at a distance from the first area 30. As shown in FIG. 4, the window 28 may provide an enlarged view of the first area 30. The user may then modify the content in the window 28 with the pen 24 (by performing a touch or touch screen operation wherein the pen 24 contacts the enlarged view in the window 28). For example, as shown in FIG. 5, the user may darken a feature of the image 26 in the enlarged view of the window 28. It is to be understood that although the editing operating described above comprises darkening a feature, any suitable editing operation may be provided. For example, the image may be edited feature may lighten, erase, or change a color of the feature. However, these are merely non-limiting examples and any operation to modify the image may be permitted in the window 28. It should further be noted that although window 28 is provided at a bottom right hand corner of the image 26, this is not required. For example, alternate embodiments may provide the window 28 at the top right hand corner or the bottom left hand corner. However, any suitable window placement may be provided.

The user of the device may for example save the changes in the enlarged view shown in the window 28. These changes may then be updated in the main view of the image 26. However, according to some embodiments of the invention, the changes/modifications made in the window 28 may occur simultaneously in the main view of the image 26.

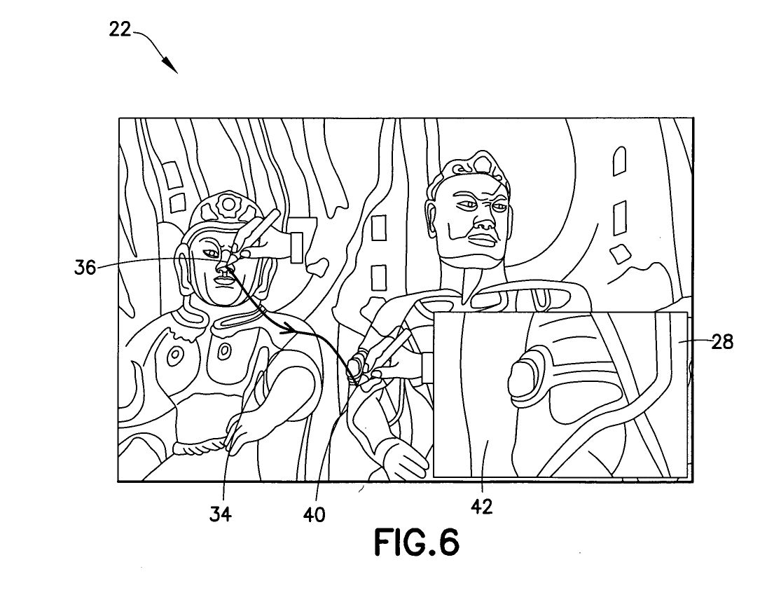

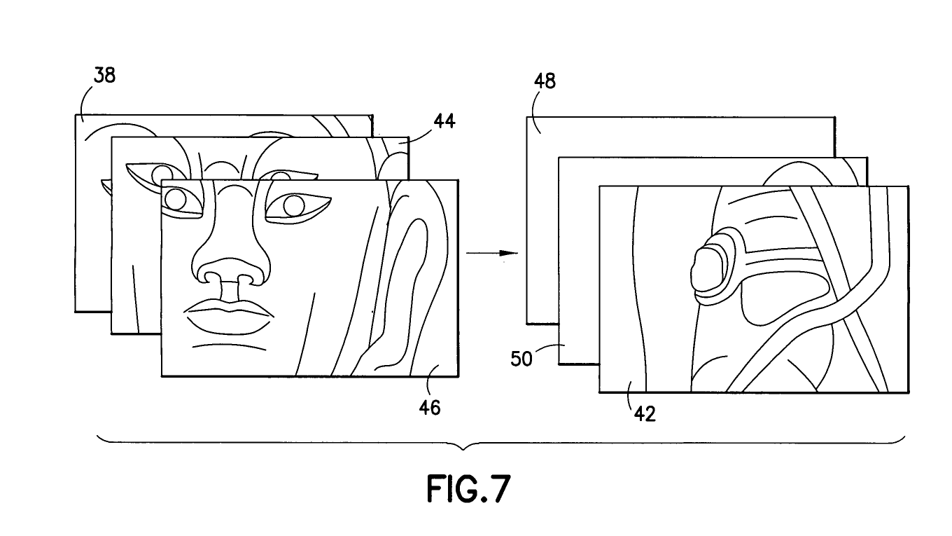

Referring now also to FIGS. 6-7, some embodiments of the invention provide for the enlarged view in the window to follow a movement of the touch on the image 26 by the pen 24. Thus, the user does not need to make accurate clicks or touches on the image 26 to select an area (to be viewed in the window 28), as the user interface supports writing a trace on the image 26, and the content of the floating window 28 will change synchronously as the pen trace 34 proceeds. For example, FIG. 6 shows a writing stroke on the image 26 wherein the user first touches the screen 22 at a first location 36. The touch screen user interface 22 senses this touch on the image 26 and provides a corresponding enlarged view 38 (FIG. 7) in the window 28. As the user moves the pen 24 along the trace 34 (from the first location 36 to a second location 40), the touch screen user interface senses the movement of the touch and provides for the view in the window 28 to change from the view 38 to a view 42 (corresponding to the location 40). FIG. 7 further illustrates intermediate views 44, 46, 48, 50, which correspond to changing views along the trace 34, between the location 36 and the location 40.

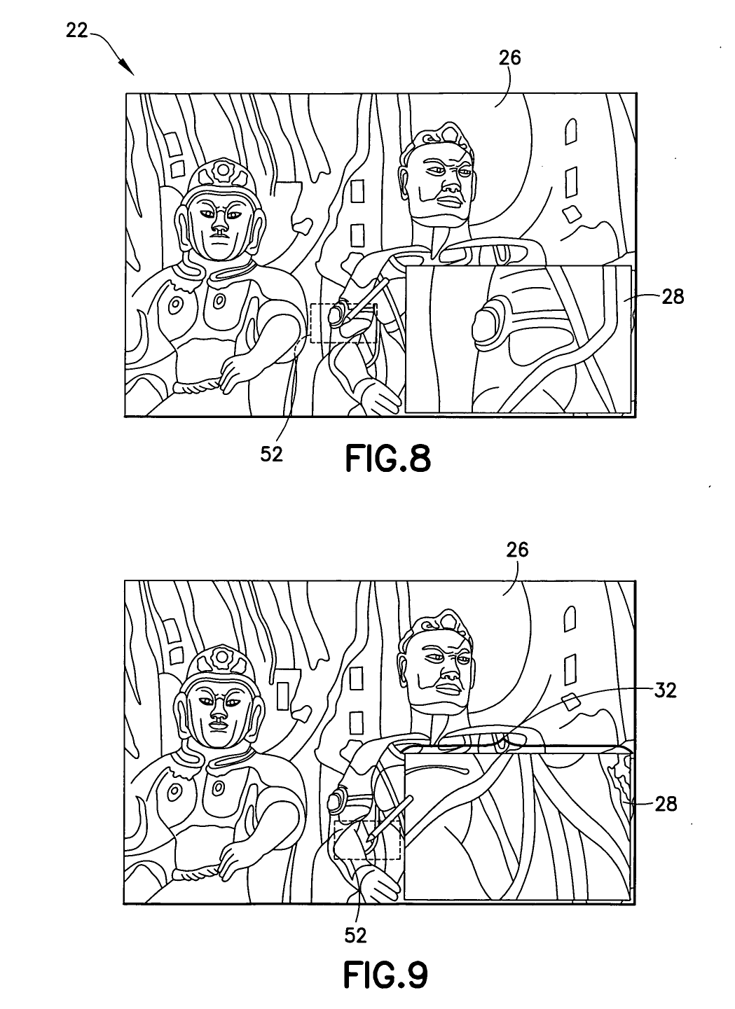

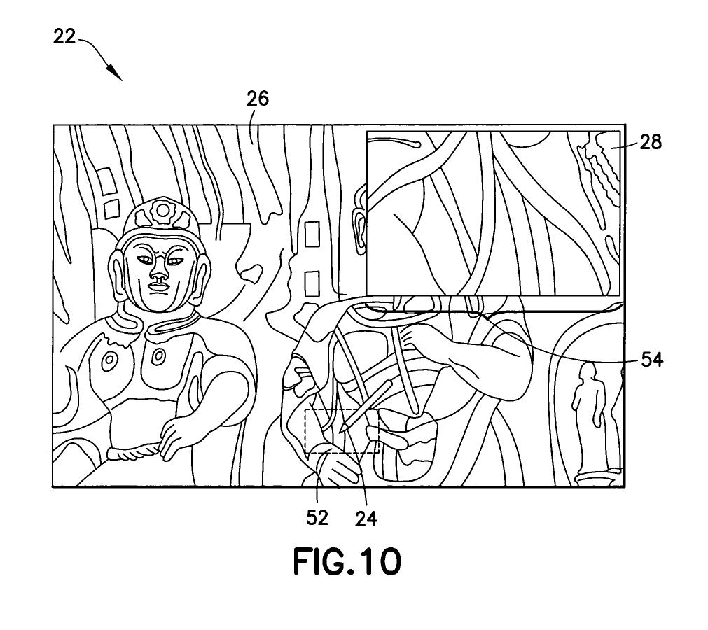

Referring now also to FIGS. 8-10, some embodiments of the invention may provide a default rectangular area 52 corresponding to the touch on the image 26 (and the enlarged view shown in the window 28) by the pen 24. Additionally, various embodiments provide for the window to move away (or float away) when the rectangular area 52 contacts (or reaches a certain distance from) the window 28. For example, if the user moves the rectangular area 52 (by changing the touch location on the display 22, for example) from the location shown in FIG. 8 (at a distance from the window 28) to the location shown in FIG. 9 (contacting or approaching the window 28), the device may sense this proximity to the window 28 and provide for the window 28 to move from the second area 32 of the image 26 to a third area (which may the top right hand corner) 54 of the image. This provides for a movable floating window 28 which moves to different areas of the image 26 in response to the movement of the pen 24 for enhance viewing capabilities. For example, some embodiments of the invention may provide for the window to be move to any suitable location at a distance from the area 52. It should be noted that any suitable size and/or shape of the area (corresponding to the pen touch) may be provided.

In addition, various embodiments of the invention may allow for the user to select the window 28 with a touch of the pen 24 for performing drag and drop operations on the window. This may allow for any suitable placement of the window 28 to location within the displayed image 26 (by dragging and dropping the window as needed).

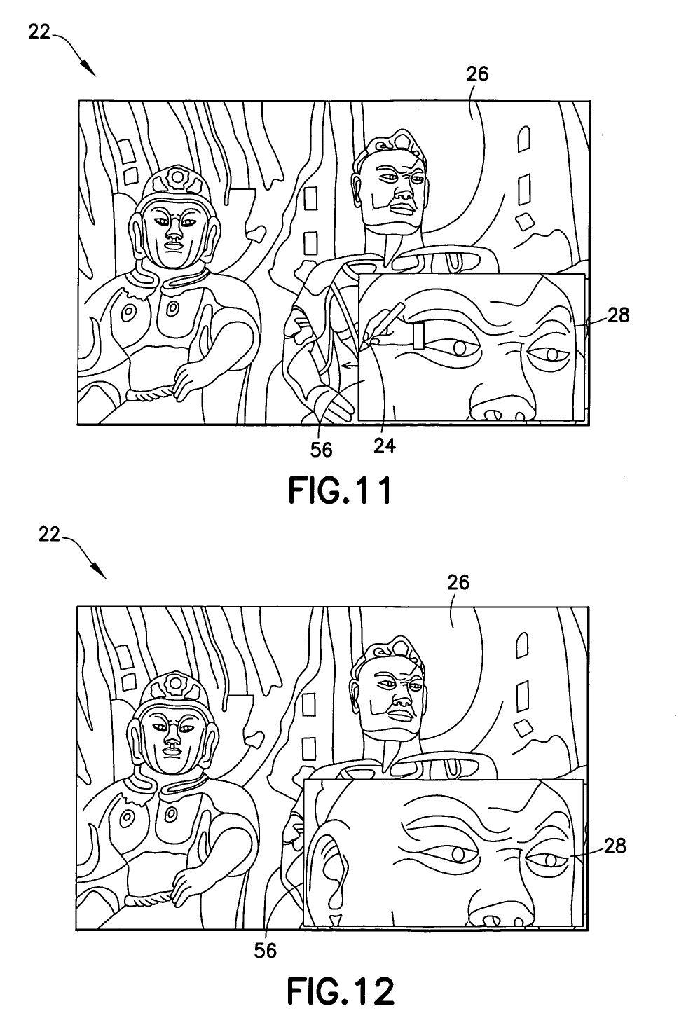

According to some embodiments of the invention, the size of the window 28 may be adjusted by performing a touch operation on the screen 22 with the pen 24 proximate an edge of the window 28. For example, as shown in FIGS. 11 and 12, the width of the window 28 may be adjusted by dragging the edge 56 of the floating window 28 in a direction away from the opposite edge. In this example, the dragging operation provides for an increased width of the window. However, it should be understood that any suitable change in size may be provided by dragging operations on edges of the window 28.

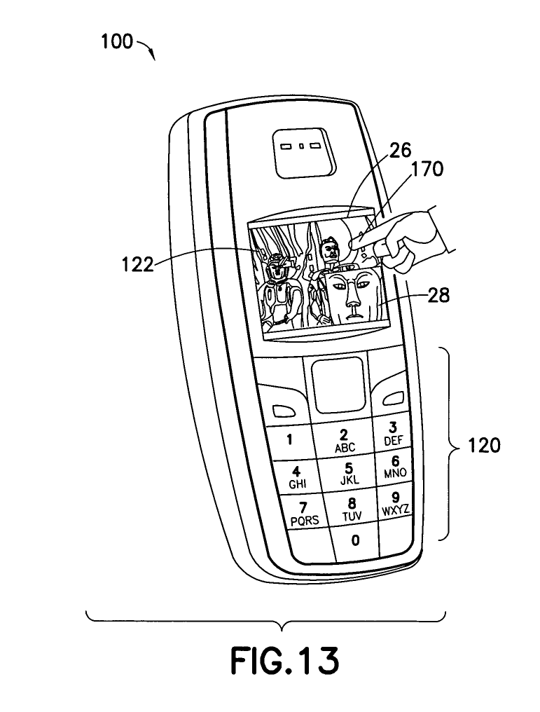

Referring now also to FIG. 13, a device 100 according to another embodiment of the invention is shown. The device 100 is similar to the device 10 and comprises a user input region 120, and a touch screen display 122. Additionally, the device 100 is configured, in a similar fashion as described above for the device 10, to provide the enlarged view (of the image 26) at the window 28. However, one difference between the device 100 and the device 10 is that the device 100 is configured to sense the touch screen operations on the touch screen 122 with a user's finger 170 (instead of with the pen or stylus).

Technical effects of any one or more of the exemplary embodiments provide for improved configurations when compared to conventional devices. For example, there are conventional configurations that provide for zooming operations at a specified area on the screen with specified pen gestures. However, these configurations are generally not intuitive enough for users to grasp at a glance. Moreover, these conventional configurations usually require extra operations to return to the original view, which may be labor some and inefficient.

Various exemplary embodiments of the invention provide improved configurations allowing for editing of the image to be available without changing an operational mode of the device. Additionally, some embodiments provide for the main image to be always visible for supporting navigation with the pen (which provides for direct and intuitive user friendly operations on the touch screen). Some embodiments of the invention may also provide for scroll bars/buttons to be eliminated from the image display area, which not only makes it convenient to operate, but also enlarges the effective area on the display (for maximization of the space within the touch sensitive screen). Further, various exemplary embodiments of the invention provide for lowered requirements on user for accurate operations (as the enlarged view displayed may follow touch movement on the screen).

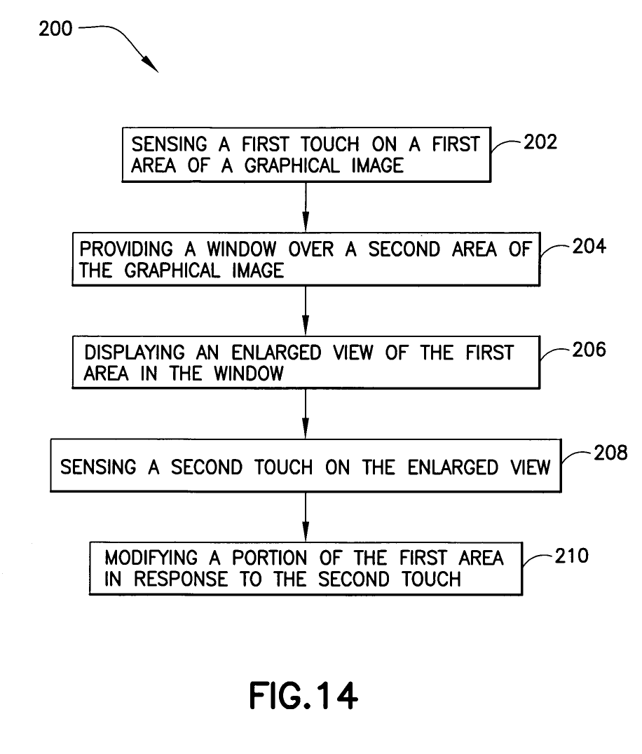

FIG. 14 illustrates a method 200. The method 200 includes the following steps. Sensing a first touch on a first area of a graphical image displayed on a screen (step 202). Providing a window over a second area of the graphical image (step 204). Displaying an enlarged view of the first area in the window (step 206). Sensing a second touch on the enlarged view of the first area in the window (step 208). Modifying a portion of the first area in response to the second touch (step 210). It should be noted that any of the above steps may be performed alone or in combination with one or more of the steps.

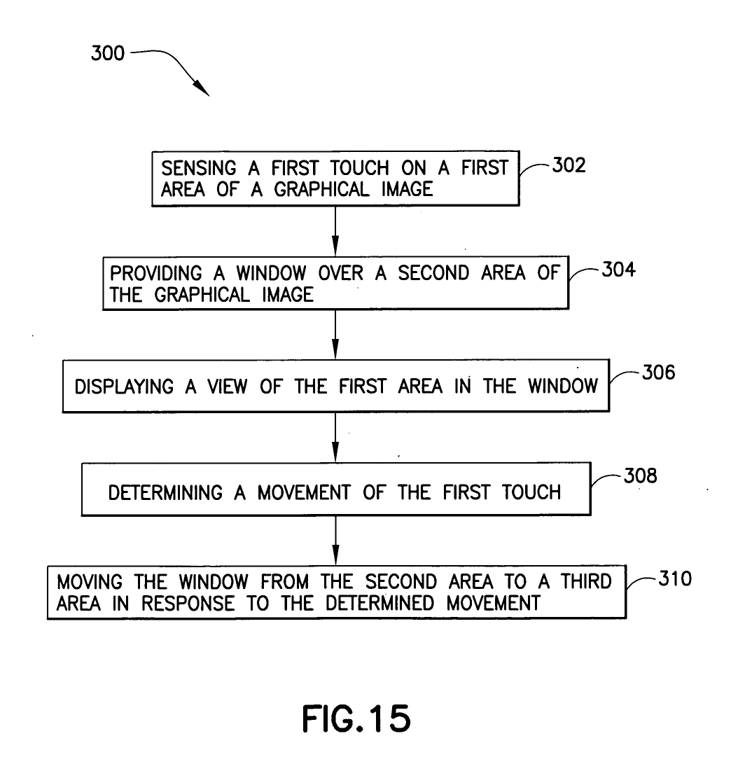

FIG. 15 illustrates a method 300. The method 300 includes the following steps. Sensing a first touch on a first area of a graphical image displayed on a screen (step 302). Providing a window over a second area of the graphical image, wherein the second area is spaced from the first area (step 304). Displaying a view of the first area in the window (step 306). Determining a movement of the first touch (step 308). Moving the window from the second area to a third area in response to the determined movement of the first touch when the determined movement of the first touch is proximate the second area (step 310). It should be noted that any of the above steps may be performed alone or in combination with one or more of the steps.

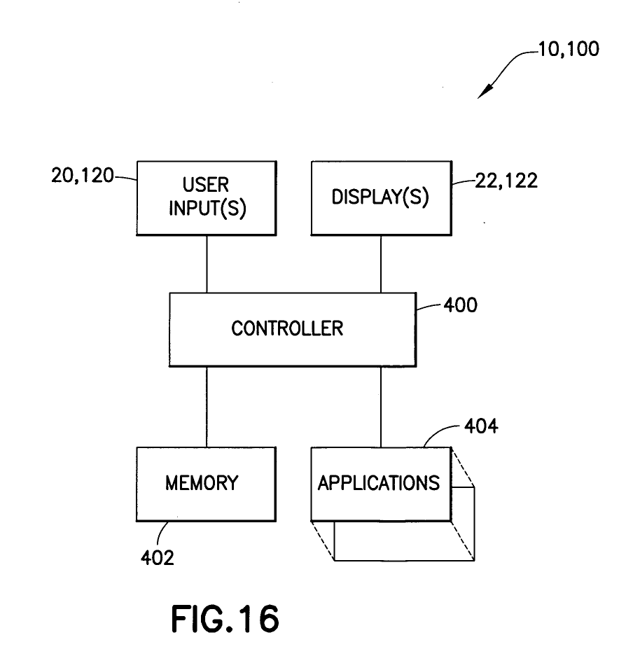

Referring now also to FIG. 16, the device 10, 100 generally comprises a controller 400 such as a microprocessor for example. The electronic circuitry includes a memory 402 coupled to the controller 400, such as on a printed circuit board for example. The memory could include multiple memories including removable memory modules for example. The device has applications 404, such as software, which the user can use. The applications can include, for example, a telephone application, an Internet browsing application, a game playing application, a digital camera application, a map/gps application, etc. These are only some examples and should not be considered as limiting. One or more user inputs 20, 120 are coupled to the controller 400 and one or more displays 22, 122 are coupled to the controller 400. The device 10, 100 may programmed to automatically magnify or edit a portion of the image. However, in an alternate embodiment, this might not be automatic. The user might need to actively zoom or edit the image.

According to one example of the invention, an apparatus is disclosed. The apparatus includes a touch screen. The apparatus is configured to display an image having a first area on the touch screen. The apparatus is configured to simultaneously display an enlarged view of the first area on the touch screen. The apparatus is configured to receive a touch at the enlarged view of the first area on the touch screen. The apparatus is configured to edit the image in response to the touch at the enlarged view.

According to another example of the invention, a program storage device readable by a machine, tangibly embodying a program of instructions executable by the machine for performing operations to edit an image is disclosed. A first touch is sensed on a first area of an image displayed on a screen. A window is provided over a second area of the image. An enlarged view of the first area is displayed in the window. A second touch on the enlarged view of the first area is sensed in the window. A portion of the first area is modified in response to the second touch.

It should be understood that components of the invention can be operationally coupled or connected and that any number or combination of intervening elements can exist (including no intervening elements). The connections can be direct or indirect and additionally there can merely be a functional relationship between components.

It should be understood that the foregoing description is only illustrative of the invention. Various alternatives and modifications can be devised by those skilled in the art without departing from the invention. Accordingly, the invention is intended to embrace all such alternatives, modifications and variances which fall within the scope of the appended claims.

1. An apparatus comprising a touch screen, wherein the apparatus is configured to display an image having a first area on the touch screen, wherein the apparatus is configured to simultaneously display an enlarged view of the first area on the touch screen, wherein the apparatus is configured to receive a touch at the enlarged view of the first area on the touch screen, and wherein the apparatus is configured to edit the image in response to the touch at the enlarged view.

2. An apparatus as in claim 1 wherein the apparatus further comprises a pen or stylus, and wherein the pen or stylus is configured to perform a touch operation on the touchscreen.

3. An apparatus as in claim 1 wherein the apparatus is configured to display a movable window, wherein the movable window comprises the enlarged view.

4. An apparatus as in claim 1 wherein the apparatus is configured to allow the user of the apparatus to edit the portion of the first area by applying the touch on the enlarged view without changing a mode of the apparatus.

5. An apparatus as in claim 1 wherein the apparatus is a wherein the device is a portable electronic device.

6. A method comprising:
sensing a first touch on a first area of a graphical image displayed on a screen;
providing a window over a second area of the graphical image;
displaying an enlarged view of the first area in the window;
sensing a second touch on the enlarged view of the first area in the window; and
modifying a portion of the first area in response to the second touch.

7. A method as in claim 6 further comprising:
moving the window from the second area to a third area in response to the determined movement of the first touch when the determined movement of the first touch is proximate the second area.

8. A method as in claim 6 wherein the modifying of the portion of the first area further comprises editing the graphical image.

9. A method as in claim 6 wherein the providing of the window further comprises providing a movable floating window over the second area of the graphical image.

10. A method as in any of claim 6 further comprising:
sensing another touch proximate an edge of the window; and
changing a size of the window in response to the another touch.

11. A method comprising:
sensing a first touch on a first area of a graphical image displayed on a screen;
providing a window over a second area of the graphical image, wherein the second area is spaced from the first area;
displaying a view of the first area in the window;
determining a movement of the first touch; and
moving the window from the second area to a third area in response to the determined movement of the first touch when the determined movement of the first touch is proximate the second area.

12. A method as in claim 11 wherein the displaying of the view of the first area in the window further comprises displaying an enlarged view of the first area in the window.

13. A method as in claim 11 wherein the sensing of the first touch further comprises sensing the first touch on the first area of the graphical image displayed on a touch screen display of a portable electronic device.

14. A method as in claim 11 further comprising:
sensing a second touch on the view of the first area in the window.

15. A method as in claim 14 further comprising:
modifying a portion of the first area in response to the second touch.

16. A program storage device readable by a machine, tangibly embodying a program of instructions executable by the machine for performing operations to edit an image, the operations comprising:
sensing a first touch on a first area of the image displayed on a screen;
providing a window over a second area of the image;
displaying an enlarged view of the first area in the window;
sensing a second touch on the enlarged view of the first area in the window; and
modifying a portion of the first area in response to the second touch.

17. A program storage device as in claim 16 wherein the providing of the window further comprises providing a movable floating window over the second area of the image.

18. A program storage device as in claim 16 further comprising:
moving the window from the second area to a third area in response to the determined movement of the first touch when the determined movement of the first touch is proximate the second area.

19. A program storage device as in claim 16 wherein the modifying of the portion of the first area further comprises editing the image.

20. A program storage device as in claim 16 further comprising:
sensing another touch proximate an edge of the window; and
changing a size of the window in response to the another touch.
